(19) United States
(12) Patent Application Publication
(10) Pub. No.: US 2010/0160492 A1
(43) Pub. Date: Jun. 24, 2010

(54) POLYMER-ENCAPSULATED PIGMENT NANO-PARTICLES AND METHOD FOR PREPARING SAME

(76) Inventor: KANGNING LIANG, Bartlett, TN (US)

Correspondence Address: FROMMER LAWRENCE & HAUG, 745 FIFTH AVENUE- 10TH FL., NEW YORK, NY, 10151, US

(21) Appl. No.: 12/341,312

(22) Filed: Dec. 22, 2008

(51) Int. Cl. C09D 7/14

(52) U.S. Cl. 523/205

(57) ABSTRACT

A method for preparing polymer-encapsulated pigment nano-particles is disclosed. Several steps are involved in creating these polymer-encapsulated pigment nano-particles. One step is to prepare a first dispersion including particles of a pigment, a first surfactant, and a first amount of a solvent. Another step is to prepare a second dispersion including a polymer, a second surfactant, and a second amount of the solvent. Then, the first dispersion and the second dispersion are mixed together so as to form a final dispersion including the polymer, pigment particles encapsulated by the polymer, the first surfactant, the second surfactant, and the solvent. The solvent can then be removed from the aqueous dispersion to form a first solid. In addition, the first and second surfactants can be removed from the first solid to form a second solid. Finally, the second solid can be milled to form particles of pigment encapsulated by the polymer.

### BACKGROUND OF THE INVENTION

1. Field of the Invention

This invention provides a method to encapsulate pigment (in particular carbon black) particles in a polymer shell. In this method, the preparation of a polymer latex and a dispersion of carbon in water can be conducted independently. After mixing the polymer latex with the carbon dispersion, the solvent of the system is then removed through rotary evaporation or other methods. This leads to a homogeneous distribution of carbon particles inside a matrix of fine polymer particles. Next, the surfactant, along with other side products and impurities, is removed via extraction with methanol. The resulting product is then milled to form micron-sized to submicron-sized particles, which can be used for a variety of purposes. For instance, if a positively charged polymer latex is used, the milled particles can then be used as a positively charged black component for electrophoretic inks.

2. Description of Related Art

It has been long desired to modify carbon black particles so that they can form stable dispersions in various media, either for pigment purposes (e.g., printing inks and electrophoretic inks) or as reinforcing filler particles for polymers. The primary particle size of carbon black is rather small, usually in the range of a few tens of nanometers. As a result, the inter-particulate forces are very high. This causes significant aggregation of the carbon particles to occur, which in turn, results in degradation of the application properties. Furthermore, carbon black is an electrically conductive material, making it unsuitable to be directly used in some applications such as electrophoretic inks.

The encapsulation of a solid particle into a polymer shell can protect the particle against environment and impart new properties to the particle, and is therefore of great importance for a large number of applications. As a result, the approach to prevent aggregation of carbon particles in a dispersion, and to enable them suitable for use in a variety of applications, has been to encapsulate the carbon particles within a polymer shell.

There are many different approaches for encapsulating carbon black particles with a polymer shell. Generally speaking, they can be summarized into three categories: (1) dispersing carbon black into water/surfactants; (2) encapsulating carbon black by either precipitation or an emulsion polymerization; and (3) milling or kneading carbon black particles with desired oligomeric polymers.

The emulsion polymerization method utilizes the hydrophobic nature of carbon black. This incorporates the carbon black particles into droplets (micro-droplets or nano-droplets) of hydrophobic monomers formed in the surfactant/water system. Generally, this involves a miniemulsion, which is a system with small and narrowly distributed droplets ranging from 30 to 500 nm. The stability of these droplets is achieved by suppressing the Ostwald ripening through addition of a chemical that is soluble in the dispersed phase (i.e., the droplets) but insoluble in the continuous phase (i.e., the surfactant/water phase).

A modified approach was developed by Dr. Katharina Landfester, as set forth in her work: Franca Tiarks, Katharina Landfester, & Markus Antonietti, Encapsulation of Carbon Black by Miniemulsion Polymerization, MACROMOLECULAR CHEMISTRY AND PHYSICS, Vol. 202, P. 51-60 (2001). In Dr. Landfester's approach, both the monomer droplets and the carbon black particles were independently dispersed in water using sodium dodecyl sulfate (“SDS”) as a surfactant. Subsequently, the monomer dispersion and carbon black dispersion were mixed together. This combined liquid was then subjected to ultrasonic treatment, called a controlled fission/fusion process. This process destroys all aggregates and droplets first and subsequently allows the formation of only hybrid particles of carbon black surrounded by monomer droplets. Accordingly, after completion of the fission/fusion process, all the carbon particles are incorporated into monomer droplets. A subsequent polymerization of the monomer droplets permanently fixes this encapsulated nature of the carbon black particles.

However, Dr. Landfester's process has some significant drawbacks. The process strongly depends on the characteristics of the monomer and surfactant used, the amount of monomer, and sonication process. The resultant polymer-encapsulated carbon nanoparticles are dispersed in water, which cannot be used in a display device such as an electrophoretic ink component. Furthermore, Dr. Landfester's process does not provide a way to remove the continuous phase (water in this case), to purify the carbon nanoparticles by removing the side products of the polymerization and the substantial amount of surfactant in the resulting product, or to re-disperse the polymer-encapsulated carbon nanoparticles into a non-aqueous, dielectric solvent for applications in electrophoretic display. Moreover, Dr. Landfester's process does not provide a means to control the charge on the polymer-encapsulated carbon particles, which is essential to be used as an electrophoretic ink component.

In one embodiment of the current invention (as related to electrophoretic applications), positively charged polymer-encapsulated carbon nanoparticles were required. As a result, negatively charged SDS can not be used. Instead, positive types of surfactants, such as quaternary ammonium-type surfactants, were used for making polymer-encapsulated carbon black particles for an electrophoretic ink composition. However, when Dr. Landfester's process was used with quaternary ammonium-type surfactants, it was found that hybrid particles of carbon black and monomer were not formed even after a long period of ultrasonic treatment. In addition, the carbon prepared according to Dr. Landfester's method showed strong electric conductivity, implying poor or no encapsulation of the carbon particles. As a consequence, the resultant carbon black particles were not suitable to form an electrophoretic ink composition.

Thus, it was determined that, in certain cases, Dr. Landfester's method does not lead to monomer droplets which consistently encapsulated carbon nano-particles. Rather, in these cases, the carbon and monomer droplets existed individually and independently in the system. As a result, the polymerization of the monomer phase does not lead to encapsulation of carbon particles by the polymer.

As such, there exists a need for a method and process resulting in carbon black particles which are encapsulated in a polymer, where the charge of the resultant encapsulated particles can be controlled to be positive, negative, or neutral. There also exists a need for a method and process resulting in carbon black particles which are encapsulated in a polymer, where the aqueous solvent can be removed and the resulting carbon black particles can be purified by removing the surfactant(s) and byproducts so that the carbon black particles are suitable to be re-dispersed into a dielectric solvent

### SUMMARY OF THE INVENTION

In accordance with one embodiment of the invention, a method for preparing polymer-encapsulated pigment nano-particles is disclosed. Several steps are involved in creating these polymer-encapsulated pigment nano-particles. One step is to prepare a first dispersion including particles of a pigment, a first surfactant, and a first amount of a solvent. Another step is to prepare a second dispersion including a polymer, a second surfactant, and a second amount of the solvent. Then, the first dispersion and the second dispersion are mixed together so as to form an aqueous dispersion including the polymer, pigment particles surrounded by the polymer, the first surfactant, the second surfactant, and the solvent.

The solvent can then be removed from the aqueous dispersion to form a first solid. In addition, the first and second surfactants can be removed from the first solid to form a second solid. Finally, the second solid can be milled to form particles of pigment encapsulated by the polymer.

In another embodiment of the invention, a charged polymer-encapsulated pigment nano-particle is provided. This charged polymer-encapsulated pigment nano-particle includes a pigment, a polymer, and a charging agent. In this embodiment, the polymer encapsulates the pigment. In addition the charged polymer-encapsulated pigment nano-particle of this embodiment has a size of from 10 nm to 1,000 nm, preferably from 40 nm to 400 nm, and more preferably from 100 nm to 250 nm.

### BRIEF DESCRIPTION OF THE DRAWINGS

FIG. 1A illustrates a dispersion of carbon black particles in a solvent according to an embodiment of the invention.

FIG. 1B illustrates an enlarged view of one of the carbon black particles from the dispersion of FIG. 1A.

FIG. 2A illustrates a dispersion of nano-sized polymer particles in a solvent according to an embodiment of the invention.

FIG. 2B illustrates an enlarged view of one of the nano-sized polymer particles from the dispersion of FIG. 2A.

FIG. 3 illustrates a carbon/polymer dispersion resulting from mixing the carbon particle dispersion of FIG. 1A with the nano-sized polymer particles dispersion of FIG. 2A.

FIG. 4A illustrates a carbon/polymer solid resulting from removing the solvent from the carbon/polymer dispersion of FIG. 3.

FIG. 4B illustrates particles of carbon encapsulated in polymer resulting from removing the surfactants from the carbon/polymer solid of FIG. 4A.

FIG. 4C illustrates an enlarged view of one embodiment of a particle of carbon encapsulated in polymer from FIG. 4B.

FIG. 4D illustrates an enlarged view of another embodiment of a particle of carbon encapsulated in polymer from FIG. 4B.

FIG. 5 depicts an image of a particle of carbon encapsulated in polymer of the Example of dry milling described below

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

The following embodiment provides a method for encapsulating carbon black with a positively charged polymer. First, a carbon black dispersion and a corresponding polymer latex dispersion containing a positive charging agent and a cross-linking agent are independently formed.

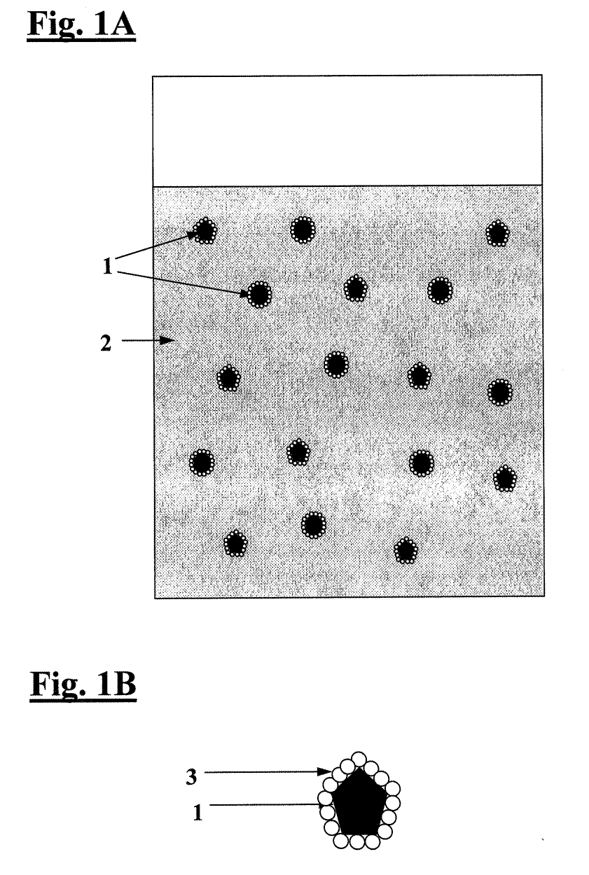

As shown in FIG. 1A, the carbon black dispersion includes particles of carbon black 1 surrounded by a surfactant 3 are dispersed in an amount of a solvent 2. An enlarged view of one of the particles of carbon black 1 surrounded by a surfactant 3 is shown in FIG. 1B.

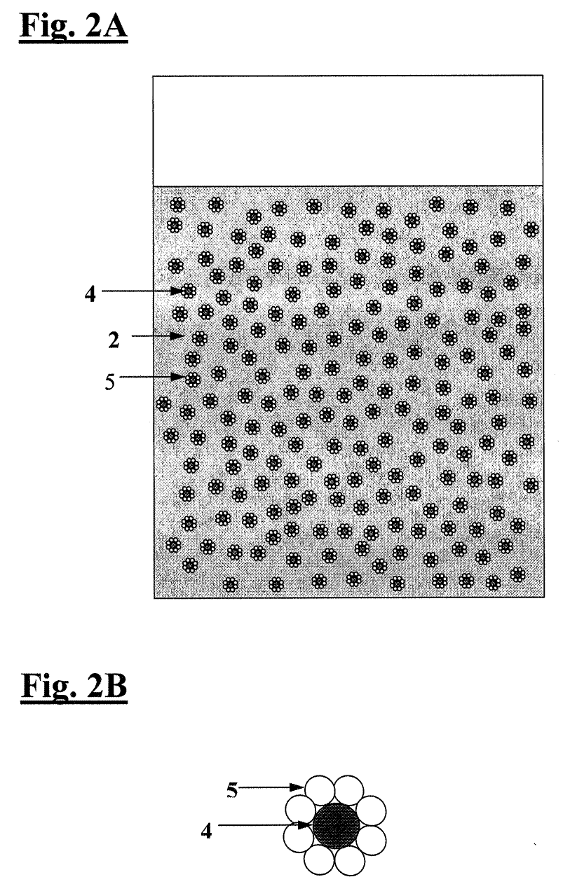

As shown in FIG. 2A, in addition to the positive charging agent (not shown) and the cross-linking agent (not shown), the polymer latex dispersion includes nano-sized polymer particles 4 surrounded by a surfactant 5 are dispersed in an amount of solvent 2. An enlarged view of one of the nano-sized polymer particles 4 surrounded by a surfactant 5 is shown in FIG. 2B. The surfactants 3 and 5 may be the same or may be different from one another.

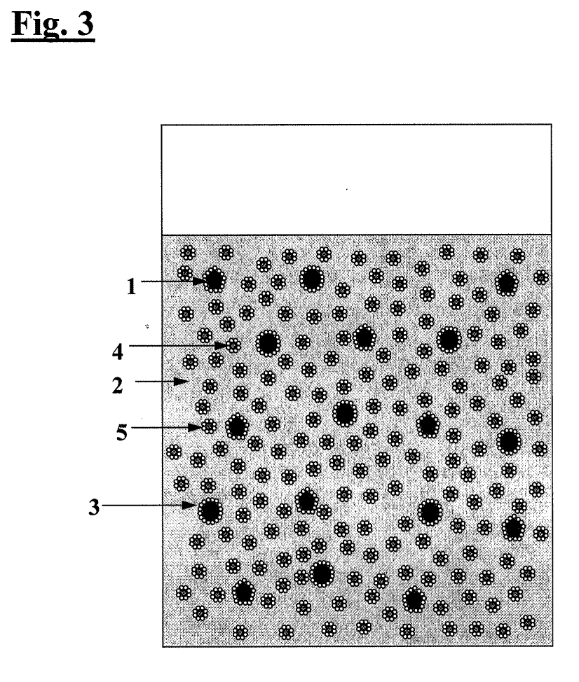

Next, as shown in FIG. 3, the carbon black dispersion and the polymer latex dispersion are mixed together so that the carbon black particles 1 are surrounded by the nano-sized polymer particles 4 in a carbon/polymer dispersion.

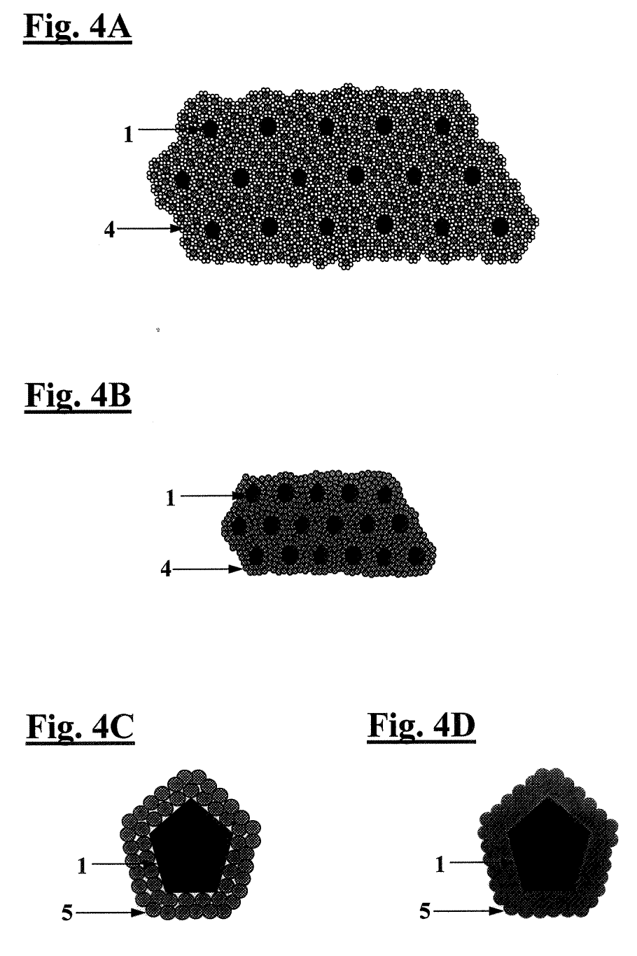

As shown in FIG. 4A, this liquid combination is then dried into solid form in a controlled fashion. As a result, all the carbon black particles 1 are homogeneously distributed in a matrix of polymer nanoparticles. That is, each carbon particle 1 is surrounded by nano-sized polymer particles 4. It should be noted that the polymers used in this embodiment contain non-volatile surfactants. In this way, the surfactants are not removed along with the solvent.

As shown in FIG. 4B, the side products resulting from the synthesis of the polymer latex, the surfactant 3, and the surfactant 5 used in forming the carbon/polymer dispersion are then removed through extraction with appropriate solvents. Examples of appropriate solvents include methanol, ethanol, isopropanol, and similar solvents.

FIG. 4C shows an enlarged view of one embodiment of a carbon black particle 1 surrounded by the nano-sized polymer particles 4. In FIG. 4C, after impurities and surfactants are removed, the nano-sized polymer particles 4 are closely packed around the surface of the carbon particles 1, where the nano-sized polymer particles 4 may maintain their individuality.

FIG. 4D shows an enlarged view of another embodiment of a carbon black particle 1 surrounded by the nano-sized polymer particles 4. As shown in FIG. 4D, the nano-sized polymer particles 4, rather than maintain their individuality, may instead coalesce to form a coating on the surface of the carbon particles 1.

After extraction, the resulting encapsulated carbon black can be milled and then used as a positively charged black ink component for electrophoretic display devices. The size of these polymer-encapsulate carbon nano-particles ranges from 10 nm to 1,000 nm, preferably from 40 nm to 400 nm, and more preferably from 100 nm to 250 nm.

Although the above embodiment only utilizes non-volatile quaternary ammonium surfactants, any non-volatile surfactant compatible with the desired charge on the resulting polymer-encapsulated carbon black, and capable of dispersing carbon in water and forming a miniemulsion with a monomer, can be used. For example, if negatively charged, polymer-encapsulated carbon particles are desired, then a negatively or neutrally charged surfactant and a polymer containing a negative charging agent can be used. Neutral surfactants and polymers containing a positive charging agent can also be used if a positive charge for the encapsulated particles is desired.

Preparation of PMMA-Based Polymer Latex

The polymer shell, which surrounds the particles of carbon black, shields the carbon black particles from the environment and provides the carbon black particles with new properties. For example, in an electrophoretic display device, the polymer shell shields the carbon black particles from the dielectric solvent in which the carbon black particles are suspended or dispersed while providing them with charging capability and other properties that the polymer possesses. In order to increase the chemical stability and solvent resistance of the encapsulated particles, a certain degree of cross-linkage within the polymer is desired. In addition, if the encapsulated particles are to be used in an electrophoretic display device, a charging agent must be incorporated into the polymer shell so that the encapsulated carbon black particles can be positively or negatively charged when they are suspended in a dielectric solvent.

In the current embodiment, poly(methyl methacrylate) (“PMMA”) is chosen as the polymer for the shell. In order to positively charge the encapsulated particles, a positive charging agent is needed. For example, positive charging agents used in conjunction with electrophoretic devices are mainly composed of nitrogen-containing organic compounds (e.g., amines, ammonium salts, pyridinium salts, amides, imides, etc.). In the case where negative charge is required, a negative charging agent can be used. For example, carboxylic acids and their salts, organic sulfates and sulphonates, organic phosphates, and so forth, are some commonly used negative charging agents. Although a charging agent can be incorporated into the polymer as an additive, in electrophoretic devices, it is important that the charging agent does not diff-use into the dielectric solvent and exchange with other oppositely charged particles. In typical two-colored electrophoretic inks there are two types of pigment particles: black particles (e.g., carbon black) and white particles (e.g., TiO₂). Each type of particle, black and white respectively, is oppositely charged. It is essential that the two different types of charging agents used with the black and white particles respectively do not diffuse into the dielectric solvent, consequently causing performance degradation or even failure of the ink. Therefore, a charging agent that can be chemically incorporated into the polymer can best serve this purpose. That is, a charging agent can react with the monomer of the polymer to form a copolymer in which the charging agent is linked to the polymer by chemical bonds. In a system requiring a positive charging agent, a polymerizable amide (e.g., N,N-dimethylacrylamide (“DMAA”)) may be used as the positive charging agent for carbon black so that it can be chemically linked to the shell polymer. This ensures that the charging agent can neither diffuse into the solvent nor change the molar ratio between DMAA and monomer unit of polymer PMMA. In addition, a cross-linking agent (e.g., di(ethylene glycol) dimethacrylate (“DEDMA”)) is used to enable a certain degree of cross-linkage in the polymer. A cross-linked polymer offers several benefits (e.g., higher chemical and physical stability, higher glass transition temperature, better resistance to solvent, etc.).

During the polymerization process, the stability of the monomer droplets is maintained by suppressing the Ostwald ripening through the addition of a hydrophobic agent (“hydrophobe”). The hydrophobe cannot diffuse from one droplet to another, and thus becomes trapped in each polymer droplet due to its extremely low solubility in water. In such a system, a high boiling point hydrocarbon liquid (e.g., Isopar V) may be used as the hydrophobe.

Where encapsulated carbon black is required to carry positive charge in an electrophoretic ink formulation, the surfactant used in making the PMMA latex in such a situation must be either positively or neutrally charged. In this way, the surfactant will not interfere with the performance of the positive charging agent, DMAA. In the current embodiment, a compound selected from a class of non-volatile quaternary ammonium salts (i.e., trimethyl alkyl ammonium halides) is used as the surfactant to form the miniemulsion of the monomer droplets in water. More specifically, three long chain surfactants (i.e., octadecyltrimethyl ammonium bromide (“OTAB”), cetyltrimethyl ammonium bromide (“CTAB”), lauryltrimethyl ammonium bromide (“LTAB”)) may be used. In the case where a negatively encapsulated charged carbon black is required for an electrophoretic ink formulation, the surfactant used in making PMMA latex must be either neutrally or negatively charged. For example, neutral surfactants such as Pluronic series and negative surfactants such as SDS, long chain carboxylates, sulfates, sulphonates, and phosphates can be used.

To initialize the polymerization, a water soluble initiator (e.g., 2,2′-azobis(2-methylpropionamidine)dihydrochloride (“AIBA”)) may be used to initialize the polymerization. An oil-soluble initiator (e.g., benzoyl peroxide, 2,2′-azobisisobutyronitrile) may also be used to initiate the polymerization by dissolving it into the monomer phase.

Example of Method of Preparing Encapsulated Carbon Black for Use in an Electrophoretic Device:

Preparation of PMMA Latex

A specific example of method of preparing encapsulated carbon black for use in an electrophoretic device will now be described in detail. First, the components of the monomer phase (i.e., methyl methacrylate (“MMA”) (3.01 g), N,N-dimethyl methacrylamide (“DMAA”) (0.205 g), diethylene glycol dimethacrylate (DEDMA) (0.294 g), and Isopar V (0.097 g)) were mixed in a 300-mL flask. Into the flask was added 250 mL of 0.4% (by weight) CTAB solution. This mixture was then vigorously stirred for 30 minutes, after which the mixture was sonicated in a bath ultrasonicator under ambient conditions (i.e., room temperature and regular atmosphere) for 200 minutes. Next, an argon stream was introduced into the flask to drive air out of the system. To this mixture was added 5 ml of a solution containing 0.367 g of AIBA. The mixture was then brought to 65° C. and maintained at that temperature for 18 hours under continuous stirring and argon atmosphere, after which the mixture was cooled down to room temperature. Then, the resultant PMMA-based latex was stored under ambient conditions. The particle size of this latex was measured on a Brookhaven ZetaPALS instrument. The effective diameter of the latex was measured to be 35.6 nm.

Preparation of Carbon Dispersion

A hydrophobic carbon black was acquired from Elementis. Although many surfactants can aid the dispersion of carbon black into water, a positively charged encapsulated carbon particle is desired for the current embodiment. Accordingly, examples of surfactants which are suitable for this purpose include CTAB, OTAB, and LTAB. Typically, 2.855 grams of carbon was dispersed into 150 mL of 0.4% CTAB solution through sonication and centrifugation. The particle size of the carbon black in the resultant dispersion was then measured on a Brookhaven ZetaPALS instrument and a Toshiba S4700 Scanning Electron Microscope. Typically, the effective diameter of the carbon black particles was about 230 nm.

Formation of Encapsulated Carbon and Purification

The PMMA-based latex and carbon dispersion were then mixed together to form a PMMA-carbon dispersion. Next, the solvent of the PMMA-carbon dispersion (in this case water) was removed using a rotary evaporator. Of course, other types of drying methods are also feasible (e.g., frozen drying, spray drying, etc.). After complete removal of solvent, the resultant solid was crushed into fine powder. This powder contains surfactant and side products of the polymerization, which need be removed. The surfactant and side products were then extracted from the powder using methanol on a Soxhlet extractor for 7 hours. The resulting encapsulated carbon solids were characterized with a Toshiba S4700Scanning Electron Microscope, a Perkin Elmer Spectrum 100 FT-IR Spectrometer, and energy dispersive X-ray spectroscopy measured on an EDAX/EDS system.

Milling of Encapsulated Carbon for EP Ink Formulation

To obtain micron to sub-micron size particles that are suitable for electrophoretic ink formulation, the encapsulated carbon needs be processed in a way similar to that used when making toners. Milling on a SynergyLabs Pulverisette 7 Micromill was employed in our work to generate micron-sized to submicron-sized encapsulated carbon particles. A typical process of this milling will now be described. To a mortar was added 0.15 g of encapsulated carbon. This solid was then thoroughly ground with a pestle, and transferred into a 12-mL agate milling bowl containing 50 5-mm diameter agate beads. Into the milling bowl was added 4.5 g of 1-octanol-decane (15% 1-octanol by weight). This mixture was then milled at a rotational speed of 800 rpm for 7 hours.

After the black dispersion was recovered from the milling bowl, the particle size of the encapsulated carbon black was measured on a Toshiba SEM S4700 Scanning Electron Microscope and a Brookhaven ZetaPALS instrument. The result from the Brookhaven ZetaPALS instrument indicated that the effective diameter of the encapsulated carbon black was 310 nm measured in isopropanol.

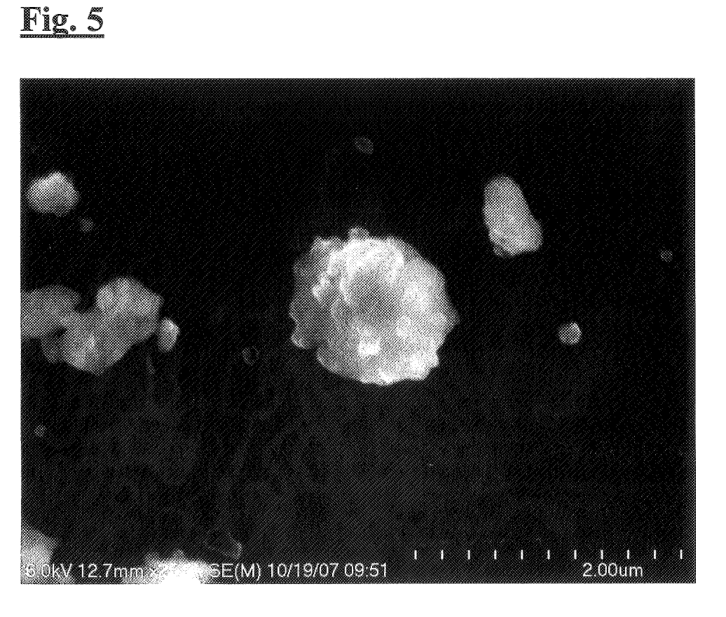

Dry milling of the carbon material can also be employed to obtain micron-sized to submicron-sized particles. A typical process of such a dry milling will now be described. To a 12-ml agate milling bowl containing 10.13 g of 1.55 mm diameter glass beads, was added 2.07 g of the encapsulated carbon. The encapsulated carbon was then milled for a total of 300 minutes at 800 rpm on the Micromill. The resulting particles were characterized on the Toshiba SEM S4760 instrument, as shown in FIG. 5.

The particles synthesized in the above embodiments carry positive charges when they are dispersed in a dielectric solvent or mixed solvent (e.g., decane and 1-octanol-decane solvents).

The method of the current invention offers several advantages over Dr. Landfester's approach. First of all, it allows for better control over the ratio of carbon to polymer and the feasibility of having a very high carbon content. Secondly, it simplifies the production process by eliminating the fission/fusion process. The key step in Dr. Landfester's method is the fission/fusion process caused by ultrasonic treatment. However, it is very difficult to ensure the formation of carbon-monomer hybrid particles with such a method, especially in a large-scale production process. Furthermore, the effectiveness of Dr. Landfester's fission/fusion process is strongly dependent on many factors (e.g., surfactant type, monomer properties, additives, etc.). Thirdly, the method of the current invention enables easy modification of the product by simply varying the type of polymer latex, adding new additives into the system, using more than one type of polymer latex for new properties, or any combination of the above. Fourthly, the method of the current invention makes it possible to encapsulate carbon with a polymer or polymers that are not compatible with carbon (e.g., a fluoro-polymer). Fifthly, the method of current invention allows the purification of the encapsulated carbon black particles, and enables them to be used in a non-aqueous dielectric solvent (e.g., the black component of electrophoretic ink).

While the above embodiments of the invention specifically relate to carbon black, the above invention is not limited thereto. For example, the above invention may be used with any colorant which is insoluble in water (e.g., colored pigments). In addition, as mentioned above, another embodiment of the method can be applied to carbon black, or other pigments, that require negative charge.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

What is claimed is:

1. A method for preparing polymer-encapsulated pigment nano-particles comprising:
preparing a first dispersion comprising:
particles of a pigment;
a first surfactant; and
a first amount of a solvent;
preparing a second dispersion comprising:
a polymer;
a second surfactant; and
a second amount of the solvent; and
mixing the first dispersion with the second dispersion so as to form a final dispersion comprising:
the polymer;
pigment particles surrounded by the polymer;
the first surfactant;
the second surfactant;
and the solvent.

2. The method of claim 1;
wherein the solvent includes water, such that the final dispersion is an aqueous dispersion; and
wherein the pigment is carbon black.

3. The method of claim 1;
wherein the second dispersion further comprises a positive charging agent.

4. The method of claim 3;
wherein the positive charging agent comprises a nitrogen-containing compound.

5. The method of claim 1;
wherein the second dispersion further comprises a negative charging agent.

6. The method of claim 5;
wherein the negative charging agent comprises a compound selected from the group carboxylic acids and their salts, organic sulfates and sulphonates, and organic phosphates.

7. The method of claim 1;
wherein the second dispersion is prepared by a method comprising:
preparing a third dispersion comprising:
a monomer;
the second surfactant;
a hydrophobe;
a cross-linking agent; and
water; and
initiating polymerization of the monomer of the third dispersion in order to form the second dispersion.

8. The method of claim 7;
wherein the second dispersion further comprises a positive charging agent.

9. The method of claim 7;
wherein the second dispersion further comprises a negative charging agent.

10. The method of claim 1, further comprising:
removing the solvent from the final dispersion to form a first solid;
removing the first and second surfactants from the first solid to form a second solid; and
milling the second solid to form particles of pigment encapsulated by the polymer.

11. The method of claim 3, further comprising:
removing the solvent from the final dispersion to form a first solid;
removing the first and second surfactants from the first solid to form a second solid; and
milling the second solid to form positively charged particles of pigment encapsulated by the polymer.

12. The method of claim 5, further comprising:
removing the solvent from the final dispersion to form a first solid;
removing the first and second surfactants from the first solid to form a second solid; and
milling the second solid to form negatively charged particles of pigment encapsulated by the polymer.

13. A charged polymer-encapsulated pigment nano-particle comprising:
a pigment;
a polymer; and
a charging agent;
wherein the polymer encapsulates the pigment; and
wherein the charged polymer-encapsulated pigment nano-particle has a size of from 10 nm to 1,000 nm.

14. The charged polymer-encapsulated pigment nano-particle of claim 13;
wherein the charged polymer-encapsulated pigment nano-particle has a size of from 40 nm to 400 nm.

15. The charged polymer-encapsulated pigment nano-particle of claim 13;
wherein the charged polymer-encapsulated pigment nano-particle has a size of from 100 nm to 250 nm.
